(19) United States
(12) Patent Application Publication
(10) Pub. No.: US 2026/0359789 A1
(43) Pub. Date: Nov. 12, 2026

(54) PROJECT BOARD AS A LEDGER FOR HUMAN-AI-AGENT INTERDEPENDENT COLLABORATION

(71) Applicant: monday.com Ltd., Tel Aviv (IL)

(72) Inventors: Tom BOGIN, Ramat Gan (IL); Oron MORAD, Kiryat Ono (IL); Alon SEGAL, Alfei Menashe (IL)

(73) Assignee: monday.com Ltd., Tel Aviv (IL)

(21) Appl. No.: 19/695,457

(22) Filed: Jun. 2, 2026

Related U.S. Application Data
(63) Continuation of application No. PCT/IL2026/050061, filed on Jan. 19, 2026.
(60) Provisional application No. 63/802,765, filed on May 9, 2025.
(60) Provisional application No. 63/837,205, filed on Jul. 2, 2025.
(60) Provisional application No. 63/883,111, filed on Sep. 17, 2025.

(51) Int. Cl. G06Q 10/10; G06F 8/77; G06Q 10/0631

(52) U.S. Cl. CPC G06Q 10/103; G06F 8/77; G06Q 10/06317

(57) ABSTRACT

There is provided a method, comprising: presenting within a project board, ledger entries stored by an event-sourced state ledger, executing a LLM that transforms a high-level user intent into granular tasks for execution by entities, populating the event-sourced state ledger with the granular tasks as the ledger entries, wherein for each granular task that can be performed in accordance with its dependency relationship the system enforces assignment of an owner that is granted permission to update the completion status of the granular task and for enabling the owner to attend to the task according to the task description, monitoring completion statuses for handing-off granular tasks assigned to current owners to other entities via an atomic ownership protocol engine that executes atomic claim-work-handoff transactions designed for preventing concurrent execution conflicts between entities, updating the event-sourced state ledger according to the assigning and/or handing-off, and updating the presentation of the project board.

### RELATED APPLICATIONS

This application is a Continuation of PCT Patent Application No. PCT/IL2026/050061 having International filing date of Jan. 19, 2026 which claims the benefit of priority under 35 USC § 119(e) of U.S. Provisional Patent Application Nos. 63/802,765 filed on May 9, 2025, 63/837,205 filed on Jul. 2, 2025 and 63/883,111 filed on Sep. 17, 2025. The contents of the above applications are incorporated by reference as if fully set forth herein in their entirety.

### BACKGROUND

The present disclosure relates to project boards, and more particularly to systems and methods for generating and presenting project boards for software development.

Project boards in software development are visual tools that track tasks, progress, and priorities across a project. They typically organize work into columns such as “To Do,” “In Progress,” and “Done.” Teams use them to coordinate efforts, manage workloads, and identify bottlenecks. Project boards support transparency, help maintain momentum, and fit naturally with Agile workflows.

### SUMMARY

According to a first aspect, a system for project board-based orchestration of entities collaborating on a project, comprises: one or more processors configured to: present on a display, a project board built on a platform designed for collaboration by a plurality of entities, including AI-agent instances and human users, manage and present within the project board, ledger entries stored by an event-sourced state ledger, receive high-level user intent for implementing a project, execute a large language model (LLM) that transforms the high-level user intent into a plurality of granular tasks for execution by entities, wherein each granular task comprises at least the following data: task ownership assignment, task description, dependency relationships, and completion status, populate the event-sourced state ledger with the plurality of granular tasks as the ledger entries, wherein for each granular task that can be performed in accordance with its dependency relationship the system enforces assignment of an owner that is granted permission to update the completion status of the granular task and for enabling the owner to attend to the task according to the task description, monitor completion statuses for handing-off granular tasks assigned to current owners to other entities via an atomic ownership protocol engine that executes atomic claim-work-handoff transactions designed for preventing concurrent execution conflicts between entities, update the event-sourced state ledger according to the assigning and/or handing-off, and update the presentation of the project board according to the updated event-sourced state ledger.

According to a second aspect, a computer-implemented method for project board-based orchestration of entities collaborating on a project, comprises: presenting on a display, a project board built on a platform designed for collaboration by a plurality of entities, including AI-agent instances and human users, managing and present within the project board, ledger entries stored by an event-sourced state ledger, receiving high-level user intent for implementing a project, executing a large language model (LLM) that transforms the high-level user intent into a plurality of granular tasks for execution by entities, wherein each granular task comprises at least the following data: task ownership assignment, task description, dependency relationships, and completion status, populating the event-sourced state ledger with the plurality of granular tasks as the ledger entries, wherein for each granular task that can be performed in accordance with its dependency relationship the system enforces assignment of an owner that is granted permission to update the completion status of the granular task and for enabling the owner to attend to the task according to the task description, monitoring completion statuses for handing-off granular tasks assigned to current owners to other entities via an atomic ownership protocol engine that executes atomic claim-work-handoff transactions designed for preventing concurrent execution conflicts between entities, updating the event-sourced state ledger according to the assigning and/or handing-off, and updating the presentation of the project board according to the updated event-sourced state ledger.

In a further implementation form of the first and second aspects, the atomic ownership protocol engine is configured to prevent concurrent execution of the same granular task by two entities.

In a further implementation form of the first and second aspects, each granular tasks is associated with a plurality of allocated resources for executing the granular task, wherein the atomic ownership protocol engine is configured to deny the plurality of allocated resources access to change the status of the granular task.

In a further implementation form of the first and second aspects, the one or more processors are configured to execute a capacity optimization scheduler operating across a plurality of projects that treats each granular task as a resource-constrained job with capability vectors and deadline constraints.

In a further implementation form of the first and second aspects, the one or more processors are configured to dynamically rebalance the assignments of granular tasks to entities in real-time according to the resource-constrained job determined by the capacity optimization schedule, as granular task dependencies and/or availability of the entities change.

In a further implementation form of the first and second aspects, the one or more processors are configured to compute a priority score for each task as a function of (i) a task dependency graph state and (ii) an AI-agent-task capability similarity metric, and trigger AI-agent instances to select granular tasks with scores exceeds a threshold, and upon completion of the selected granular tasks append a handoff event that deterministically reassigns ownership for review, wherein the handoff event is accompanied with context about the work done by the current owner.

In a further implementation form of the first and second aspects, a capacity optimization scheduler assigns the plurality of entities to granular tasks based on the computed priority scores and based on the capability profiles of the plurality of entities.

In a further implementation form of the first and second aspects, the priority scores are computed based on at least one of: complexity metrics, dependency relationships, and resource availability, to enable autonomous selection and executing of tasks by AI-agent instances operating in parallel.

In a further implementation form of the first and second aspects, the one or more processors are configured for implementing a task-granularity refinement loop, by iteratively collecting feedback regarding execution of each granular task, and programmatically creating at least one child task for at least one granular task, the at least one child task is gated by dependency graph invariants.

In a further implementation form of the first and second aspects, the feedback comprises status input indicative of failure of executing the task, and the at least one child task is created for increasing likelihood of success.

In a further implementation form of the first and second aspects, the one or more processors are configured for computing a level of granularity of the at least one child process based on available resources, wherein weaker AI-agent instances are assigned more simple granular tasks, and strong AI-agents instances are assigned to more complex granular tasks.

In a further implementation form of the first and second aspects, the one or more processors are configured for computing a level of granularity of the at least one child process based on at least one external consideration selected from: financial resource availability, user request, designed amount of collaboration, and requirement for a human in the loop.

In a further implementation form of the first and second aspects, the one or more processors are configured to automatically reassign ownership of a granular task from one entity to another in response to a task status change.

In a further implementation form of the first and second aspects, the one or more processors are configured for maintaining task dependency graphs that prevent task execution conflicts and ensure prerequisite completion before dependent task initiation.

In a further implementation form of the first and second aspects, the one or more processors are configured to dynamically update the task dependency graphs as project scope changes and/or as tasks are dynamically reassigned, and to recalculate priority scores of affected granular tasks.

In a further implementation form of the first and second aspects, the one or more processors are configured to analyze complex project requirements generated in response to the high-level user intent and automatically generate the granular tasks with defined acceptance criteria and deliverable specifications.

In a further implementation form of the first and second aspects, the one or more processors are configured to process product requirement documents and project descriptions through natural language analysis to create actionable granular tasks with appropriate skill requirements and resource allocations.

In a further implementation form of the first and second aspects, the one or more processors are configured to identify maintenance tasks and automatically assigns the identified maintenance tasks to appropriate AI-agent instances based on capability matching and workload optimization.

In a further implementation form of the first and second aspects, the one or more processors are configured to maintain audit trails of ownership changes and task modifications.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system for project board-based orchestration of entities on a project, in accordance with some embodiments of the present invention;

FIG. 2 is a flowchart of a method of project board-based orchestration of entities on a project, in accordance with some embodiments of the present invention;

FIG. 3A is a schematic of an example project board depicting granular tasks, assigned owners, and collaborators prior to an ownership handoff, in accordance with some embodiments of the present invention;

FIG. 3B is a schematic of the project board of FIG. 3A following execution of an ownership handoff via an atomic ownership protocol engine, in accordance with some embodiments of the present invention;

FIG. 4 is a state diagram illustrating an ownership-handoff state machine for granular tasks as implemented by the atomic ownership protocol engine and the event-sourced state ledger, in accordance with some embodiments of the present invention; and

FIG. 5 is a schematic of another exemplary project board, in accordance with some embodiments of the present invention.

### DETAILED DESCRIPTION

The present disclosure relates to artificial intelligence-powered software development management systems, and more particularly to systems and methods for human-AI collaborative workflows.

As used herein, the terms project board, interactive project board, interactive user interface, and graphical user interface (GUI) may sometimes be interchanged.

As used herein, the terms AI-agent instance and AI-agent are used interchangeably.

As used herein, the term project may refer to software development projects, which are presented and orchestrated by a project board described herein. However, it is understood that projects in other domains may be presented and orchestrated on the project board described herein, for example, construction related projects, customer service projects, and the like.

As used herein, the terms entity and entities may refer to autonomous actors capable of claiming ownership of, executing, and/or completing granular tasks within the project board system. Entities include human users and/or AI-agent instances. Each entity may be identified by a unique entity identifier. An entity may serve as the responsible party for a granular task and/or may possesses the authority to modify task status and/or perform handoffs to other entities.

As used herein, the terms resource and resources (including allocated resources) refer to computational, infrastructural, and/or temporal assets required for task execution. The resource(s) are distinct from the entities that own and/or execute tasks. Resources include, for example: processor(s) and/or processor utilization (e.g., CPU cycles, GPU time), memory and/or memory allocation (RAM, storage space), database capacity, API call quotas, network bandwidth, execution time windows, third-party service access, and/or tooling licenses. Resources are consumed during task execution but do not possess ownership rights or decision-making authority over tasks. A single entity may require multiple allocated resources to complete a granular task. Resources may be shared across multiple entities or tasks subject to capacity constraints managed by the capacity optimization scheduler.

As used herein, the term event-sourced state ledger may refer to a data structure that stores the state of a system as a chronologically-ordered sequence of immutable event records, where each event record represents a discrete state change that occurred at a specific point in time. Unlike conventional databases that store only current state values by overwriting previous data, an event-sourced state ledger maintains a complete historical record of all state transitions by appending new events without modifying or deleting prior entries. The current state of any entity within the system may be derived by sequentially processing (replaying) the stored events from an initial state through a series of state transition functions. In the context of the present disclosure, the event-sourced state ledger may store events related to granular tasks including, for example: task creation events, ownership assignment events, ownership transfer events, status change events, dependency relationship events, and/or task completion events. Each event record in the ledger may include sufficient information to reconstruct the state change it represents, for example, a unique event identifier, timestamp, event type, affected task identifier, entity identifier, and/or a payload containing the specific data values that changed. In some embodiments, an append-only nature of the event-sourced state ledger provides an immutable audit trail of all actions performed on granular tasks, enables reconstruction of system state at any historical point in time, and/or facilitates synchronization of the project board presentation across multiple client devices by transmitting event records rather than complete state snapshots.

As used herein, the term owner when used in reference to a granular task, may refer to the single entity (e.g., human user and/or AI-agent instance) that may hold exclusive authority at a given point in time to modify the completion status of that granular task and/or to initiate handoff of the granular task to another entity. Ownership may be enforced through the atomic ownership protocol engine described herein, which may ensure that exactly one owner is assigned to each granular task at any moment, preventing concurrent modifications by multiple entities. The owner may bear responsibility for executing the work described in the task description and/or for delegating the task through a handoff transaction. Ownership may be transferable through atomic handoff operations but is not concurrent—a granular task cannot have multiple simultaneous owners. The owner identifier may be stored as part of the task's state in the event-sourced state ledger. Ownership changes may be recorded as discrete ownership transfer events.

An aspect of some embodiments of the present invention relates to systems, methods, computing devices, and/or code instructions (stored on a data storage device and executable by one or more processors) for project board-based orchestration of entity collaboration on project(s). A project board is presented on a display. The project board is built on a platform designed for collaboration by multiple entities (e.g., AI-agent instances and/or human users) on project(s), for example, software development projects, research and development projects, construction projects, and the like. Entities include users capable of executing tasks (e.g., granular tasks) of the project, including humans and/or AI-agents. Ledger entries stored by an event-sourced state ledger are managed and presented within the project board. A high-level user intent for implementing a project is received. A large language model (LLM) is executed for transforming the high-level user intent into granular tasks for execution by entities (i.e., humans and/or AI-agent instances). Each granular task includes at least the following data: task ownership assignment, task description, dependency relationships, and completion status information. The event-sourced state ledger is populated with the granular tasks as the ledger entries. Each granular task enforces assignment of a single owner at a time that is granted permission to change status of the granular task. An atomic ownership protocol engine executes atomic claim-work-handoff transactions designed for preventing concurrent execution of the same granular tasks between two or more entities. The atomic ownership protocol engine performs a handoff of currently assigned granular tasks, by reassigning the granular tasks from the current owners to other entities. In the case of a single entity including a group of humans, or a group of AI-agents, a single entity ID may be assigned to the single entity, i.e., the single entity ID is assigned to the group of humans or group of AI-agents. The event-sourced state ledger is dynamically updated according to the assignment and/or handoffs. The presentation of the project board is dynamically updated according to the updated event-sourced state ledger.

In some embodiments, the project board itself may be represented as a granular task within a higher-level project board, enabling hierarchical project management where a first project board managing a first project is treated as a single granular task entry on a second project board managing a second project of broader scope. This hierarchical structure may be recursively applied, allowing project boards to be nested at multiple organizational levels, wherein a project board at level N becomes a granular task on a project board at level N+1, thereby enabling, for example, portfolio management, program management, and/or enterprise-level orchestration through the same event-sourced state ledger and/or atomic ownership protocol mechanisms described herein. At least one embodiment described herein addresses the technical problem of presenting a project board for entity (e.g., human-AI-agent) collaboration on a project. A project includes multiple interconnected tasks, which may be simultaneously worked on by multiple entities, including humans and AI-agents. Conflicts may arise when different entities are attempting to work on (e.g., execute) the same task as the same time. At least one embodiment described herein improves upon the technology of interactive project boards presented on a display for entity (e.g., human-AI-agent) collaboration on a project, by preventing conflicts between entities collaborating on the project. At least one embodiment described herein improves upon existing project boards, which are generally manual based. At least one embodiment described herein provides the practical application of improving performance efficiency of AI-agent instances, by preventing conflicts when collaborating on a project presented on a project board. At least one embodiment described herein provides the practical application of providing an improved interactive project board for entity (e.g., human-AI-agent) collaboration on a project that automatically prevents execution conflicts between entities.

At least one embodiment solves the aforementioned technical problem, and/or improves upon the aforementioned technical field, and/or improves upon the aforementioned existing approaches, and/or provides the aforementioned practical application(s), by project board-based orchestration of entity collaboration on project(s). A project board is presented on a display. The project board is built on a platform designed for collaboration by multiple entities (e.g., AI-agent instances and/or human users) on project(s), for example, software development projects, research and development projects, construction projects, and the like. Entities include users capable of executing tasks (e.g., granular tasks) of the project, including humans and/or AI-agents. Ledger entries stored by an event-sourced state ledger are managed and presented within the project board. A high-level user intent for implementing a project is received. A large language model (LLM) is executed for transforming the high-level user intent into granular tasks for execution by entities (i.e., humans and/or AI-agent instances). Each granular task includes at least the following data: task ownership assignment, task description, dependency relationships, and completion status information. The event-sourced state ledger is populated with the granular tasks as the ledger entries. Each granular task enforces assignment of a single owner at a time that is granted permission to change status of the granular task. An atomic ownership protocol engine executes atomic claim-work-handoff transactions designed for preventing concurrent execution of the same granular tasks between two or more entities. The atomic ownership protocol engine performs a handoff of currently assigned granular tasks, by reassigning the granular tasks from the current owners to other entities. In the case of a single entity including a group of humans, or a group of AI-agents, a single entity ID may be assigned to the single entity, i.e., the single entity ID is assigned to the group of humans or group of AI-agents. The event-sourced state ledger is dynamically updated according to the assignment and/or handoffs. The presentation of the project board is dynamically updated according to the updated event-sourced state ledger.

At least one embodiment described herein relates to a machine-enforced, event-sourced state ledger that provides atomic ownership handoffs and conflict-free parallelism for entities (e.g., human/AI-agents) across projects.

At least one embodiment described herein relates to a project management board as a structured ledger to orchestrate complex software development workflows between entities (e.g., human and AI-agents).

At least one embodiment described herein relates to a system, method, and/or code that orchestrates large-scale, agentic AI software development by using a project board as a live-state ledger where tasks that are dependent on one another are dynamically owned and handed off between AI-agents and human users, creating a unified collaborative environment.

At least one embodiment addresses the technical problem of orchestrating large-scale, complex engineering projects that involve the parallel work of multiple AI-agents and human engineers. Tracking thousands of granular tasks, managing dependencies, and maintaining a clear, unified source of truth for both human and AI participants is nearly impossible with conventional project management methods.

Using existing approaches, Agile was used to plan and estimate development, due to that ceremonies such as sprint planning were needed. At least one embodiment is directed to an environment in which execution is by agents and where the way to implement a project is more around the prompting and overseeing than execution. Due to that, sprint structure might be less needed. At least one embodiment is directed towards an interactive user interface that presents one board per development project designed to enable the development team to oversee and/or orchestrate the execution of AI-agents and their collaborations with human users/collaborators.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Certain embodiments disclosed herein include devices, systems, and methods for collaborative work systems that may allow one or more users to interact with information in real time. To avoid repetition, the functionality of some embodiments is described herein solely in connection with a processor or at least one processor. It is to be understood that such exemplary descriptions of functionality apply equally to methods and computer-readable media and constitute a written description of systems, methods, and computer-readable media. The underlying platform may allow a user to structure systems, methods, or computer-readable media in many ways using common building blocks, thereby permitting flexibility in constructing a product that suits desired needs. This may be accomplished through the use of boards. A board may be a table configured to contain items (e.g., individual items presented in horizontal rows) defining objects or entities that are managed in the platform (task, project, client, deal, etc.). Unless expressly noted otherwise, the terms “board” and “table” may be considered synonymous for purposes of this disclosure. In some embodiments, a board may contain information beyond what is displayed in a table. For example, a board may further contain cell comments, hidden rows and columns, formulas, data validation rules, filters, specific formatting, audits logs, version history, cross-referencing with different boards, external linking with data sources, permissions of access or a combination thereof. Boards may include sub-boards that may have a separate structure from a board. Sub-boards may be tables with sub-items that may be related to the items of a board. Columns intersecting with rows of items may together define cells in which data associated with each item may be maintained. Each column may have a heading or label defining one or more associated data types and may further include metadata (e.g., definitions, validation rules, ranges, hyperlinks, and/or macros). When used herein in combination with a column, a row may be presented horizontally and a column vertically. However, in the broader generic sense as used herein, the term “row” may refer to one or more of a horizontal and/or a vertical presentation. A table or table structure as used herein, refers to data presented in horizontal and vertical rows, (e.g., horizontal rows and vertical columns) defining cells in which data is presented. A table structure may refer to any structure for presenting data in an organized manner, as previously discussed such as cells presented in horizontal rows and vertical columns, vertical rows and horizontal columns, a tree data structure, a web chart, or any other structured representation, as explained throughout this disclosure. A cell may refer to a unit of information contained in the table structure defined by the structure of the table. For example, a cell may be defined as an intersection between a horizontal row with a vertical column in a table structure having rows and columns. A cell may also be defined as an intersection between a horizontal and a vertical row, or as an intersection between a horizontal and a vertical column. As a further example, a cell may be defined as a node on a web chart or a node on a tree data structure. As would be appreciated by a skilled artisan, however, the disclosed embodiments are not limited to any specific structure but rather may be practiced in conjunction with any desired organizational arrangement. In addition, table structure may include any type of information, depending on intended use. As an example, when used in conjunction with a project/task management application, the table structure may include any information associated with one or more tasks, such as one or more status values, projects, time-frames/deadlines, countries, persons, teams, progress statuses, a combination thereof, or any other information related to a task. In some cases, a hierarchy may be established between different items/cells in a same row. For example, a unique identifier (UID) may be assigned to an item and the other cell of the same row may then be associated with the item or the assigned UID.

While a table view may be one way to present and manage the data contained on a board, a tables or board's data may be presented in different ways. For example, in some embodiments, dashboards may be utilized to present or summarize data derived from one or more boards. A dashboard may be a non-table form of presenting data, using, for example, static or dynamic graphical representations. A dashboard may also include multiple non-table forms of presenting data. As discussed later in greater detail, such representations may include various forms of graphs or graphics (which may also be referred to more generically as “widgets”). In some instances, dashboards may also include table structure. Software links may interconnect one or more boards with one or more dashboards thereby enabling the dashboards to reflect data presented on the boards. This may allow, for example, data from multiple boards to be displayed and/or managed from a common location. These widgets may provide visualizations that allow a user to update data derived from one or more boards.

Boards (or the data associated with boards) may be stored in a local memory on a user device or may be stored in a local network repository. Boards may also be stored in a remote repository and may be accessed through a network. In some instances, permissions may be set to limit board access to the board's “owner” while in other embodiments a user's board may be accessed by other users through any of the networks described in this disclosure. In alternative scenarios, permission may not only be provided at the board level, but also at a more granular level such as rows, columns, and even individual cells, allowing for fine-grained control over who may access, view, edit, or interact with the data included in the board, particularly useful when dealing with collaborative boards. When one user makes a change in a board, that change may be updated to the board stored in a memory or repository and may be pushed to the other user devices that access that same board. These changes may be made to cells, items, columns, boards, dashboard views, logical rules, or any other data associated with the boards. Similarly, when cells are tied together or are mirrored across multiple boards, a change in one board may cause a cascading change in the tied or mirrored boards or dashboards of the same or other owners.

Boards and widgets may be part of a platform that may enable users to interact with information in real-time in collaborative work systems involving electronic collaborative word-processing documents. Electronic collaborative word processing documents (and other variations of the term) as used herein are not limited to only digital files for word processing but may include any other processing document such as presentation slides, tables, databases, graphics, sound files, video files or any other digital document or file. Electronic collaborative word processing documents may include any digital file that may provide for input, editing, formatting, display, and/or output of text, graphics, widgets, objects, tables, links, animations, dynamically updated elements, or any other data object that may be used in conjunction with the digital file. Any information stored on or displayed from an electronic collaborative word processing document may be organized into blocks. A block may include any organizational unit of information in a digital file, such as a single text character, word, sentence, paragraph, page, graphic, or any combination thereof. Blocks may include static or dynamic information and may be linked to other sources of data for dynamic updates. Blocks may be automatically organized by the system or may be manually selected by a user according to preference. In one embodiment, a user may select a segment of any information in an electronic word-processing document and assign it as a particular block for input, editing, formatting, or any other further configuration.

An electronic collaborative word-processing document may be stored in one or more repositories connected to a network accessible by one or more users through their computing devices. In one embodiment, one or more users may simultaneously edit an electronic collaborative word-processing document. The one or more users may access the electronic collaborative word-processing document through one or more user devices connected to a network. User access to an electronic collaborative word processing document may be managed through permission settings set by an author of the electronic collaborative word processing document. Alternatively, permissions to specific portions of the electronic collaborative word-processing document may be provided in order to control access, facilitate collaboration, and ensure that different users have appropriate levels of involvement and authority over different parts of the content. An electronic collaborative word-processing document may include graphical user interface elements enabled to support the input, display, and management of multiple edits made by multiple users operating simultaneously within the same document.

Various embodiments are described herein with reference to a system, method, device, or computer readable medium. It is intended that the disclosure of one is a disclosure of all. For example, it is to be understood that disclosure of a computer-readable medium described herein also constitutes a disclosure of methods implemented by the computer-readable medium, and systems and devices for implementing those methods, via for example, at least one processor. It is to be understood that this form of disclosure is for case of discussion only, and one or more aspects of one embodiment herein may be combined with one or more aspects of other embodiments herein, within the intended scope of this disclosure.

Disclosed embodiments may include and/or access a data structure. A data structure consistent with the present disclosure may include any collection of data values and relationships among them. The data may be stored linearly, horizontally, hierarchically, relationally, non-relationally, uni-dimensionally, multi-dimensionally, operationally, in an ordered manner, in an unordered manner, in an object-oriented manner, in a centralized manner, in a decentralized manner, in a distributed manner, in a custom manner, or in any manner enabling data access. By way of non-limiting examples, data structures may include an array, an associative array, a linked list, a binary tree, a balanced tree, a heap, a stack, a queue, a set, a hash table, a record, a tagged union, ER model, and a graph. For example, a data structure may include an XML database, an RDBMS database, an SQL database, or NoSQL alternatives for data storage/search such as MongoDB, Redis, Couchbase, Datastax Enterprise Graph, Elastic Search, Splunk, Solr, Cassandra, Amazon DynamoDB, Scylla, HBase, and Neo4J. A data structure may be a component of the disclosed system or a remote computing component (e.g., a cloud-based data structure). Data in the data structure may be stored in contiguous or non-contiguous memory. Moreover, a data structure, as used herein, does not require information to be co-located. It may be distributed across multiple servers, for example, that may be owned or operated by the same or different entities. Thus, the term “data structure” as used herein in the singular is inclusive of plural data structures.

Certain embodiments disclosed herein may include a processor configured to perform methods that may include triggering an action in response to an input. The input may be from a user action or from a change of information contained in a user's table or board, in another table, across multiple tables, across multiple user devices, or from third-party applications. Triggering may be caused manually, such as through a user action, or may be caused automatically, such as through a logical rule, logical combination rule, or logical templates associated with a board. For example, a trigger may include an input of a data item that is recognized by at least one processor that brings about another action.

In some embodiments, the methods including triggering may cause an alteration of data and may also cause an alteration of display of data with different levels of granularity (e.g., a specific board, a plurality of boards.) or across an entirety of an account or entity (e.g., multiple boards, workspaces, or projects within the account). An alteration of data may include a recalculation of data, the addition of data, the subtraction of data, or a rearrangement of information. Further, triggering may also cause a communication to be sent to a user, other individuals, or groups of individuals. The communication may be a notification within the system or may be a notification outside of the system through a contact address such as by email, phone call, text message, video conferencing, or any other third-party communication application.

Some embodiments include one or more automations, logical rules, logical sentence structures, and logical (sentence structure) templates. While these terms are described herein in differing contexts, in the broadest sense, in each instance an automation may include a process that responds to a trigger or condition to produce an outcome; a logical rule may underlie the automation in order to implement the automation via a set of instructions; a logical sentence structure is one way for a user to define an automation; and a logical template/logical sentence structure template may be a fill-in-the-blank tool used to construct a logical sentence structure. While all automations may have an underlying logical rule, all automations need not implement that rule through a logical sentence structure. Any other manner of defining a process that responds to a trigger or condition to produce an outcome may be used to construct an automation.

Other terms used throughout this disclosure in differing exemplary contexts may generally share the following common definitions.

In some embodiments, machine learning algorithms (also referred to as machine learning models or artificial intelligence in the present disclosure) may be trained using training examples, for example in the cases described below. Some non-limiting examples of such machine learning algorithms may include classification algorithms, data regressions algorithms, image segmentation algorithms, visual detection algorithms (such as object detectors, face detectors, person detectors, motion detectors, edge detectors, etc.), visual recognition algorithms (such as face recognition, person recognition, object recognition, etc.), speech recognition algorithms, mathematical embedding algorithms, NLP algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may include an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes, and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyperparameters, where the hyperparameters are set manually by a person or automatically by a process external to the machine learning algorithm (such as a hyperparameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

As described herein below, the AI-agents may use a generative AI model. The generative AI model described herein may be used for enabling interactions with the project board. The architecture may be based on a hybrid approach, combining several advanced machine learning techniques such as transformer-based Architecture, similar to GPT (Generative Pre-trained Transformer) models. Multi-head self-attention mechanisms for processing both textual and structured data may be used, for instance with positional encoding to maintain sequence information in input data and/or layer normalization and residual connections for stable training and inference. Optionally, multimodal processing that incorporates separate encoding branches for different data types (e.g., text, tabular data, and/or images) is used. Optionally, byte-pair encoding (BPE) for tokenization is used. Optionally, entity embeddings for categorical variables and normalized numerical inputs may be used for processing tabular data. In some embodiments, a convolutional neural network (CNN) backbone, such as ResNet or EfficientNet is used for analyzing image built from marked area and/or pixels as described below. Cross-attention layers may be added to allow interaction between different modalities and to enable the model to align information from text queries with relevant parts of tabular or image data. Optionally, in multi-interaction process described herein below, a context buffer is maintained to store relevant information from previous interactions. Attention mechanisms may be used to selectively retrieve and apply contextual information. An autoregressive decoder may be used for generating text responses, optionally, with pointer network for referencing specific parts of the input data in responses and/or a mixture of expert modules for specialized outputs (e.g., SQL generation, data visualizations). As used herein the generative AI model may be an outcome of pre-training on large corpus of platform data and optionally general knowledge bases. Optionally the model is fine-tuned on specific datasets and use cases.

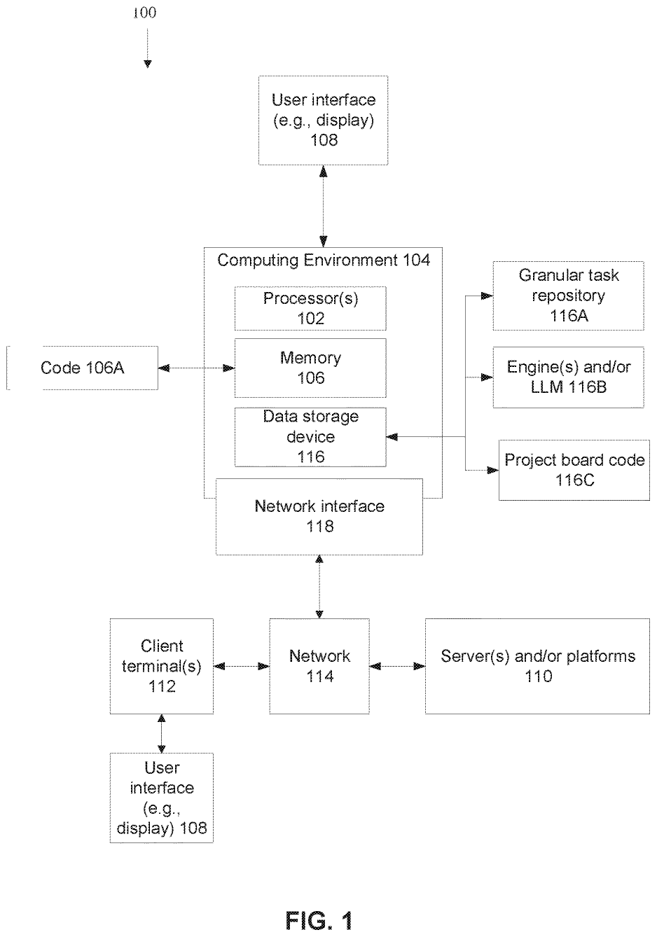

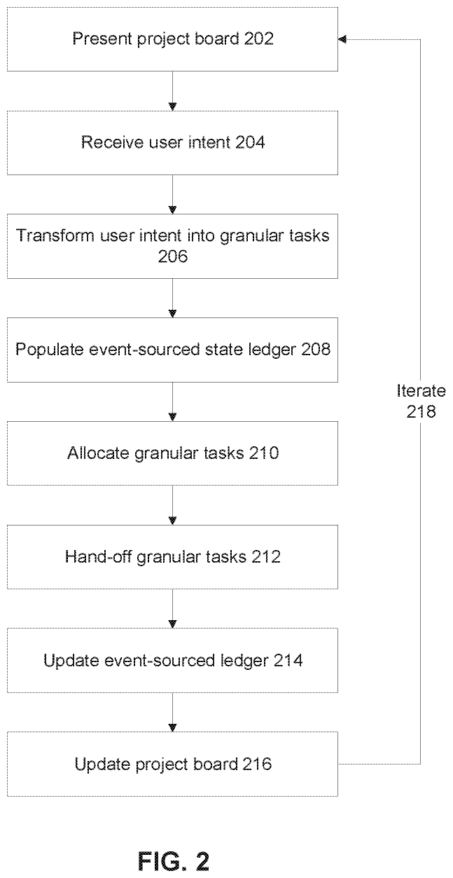

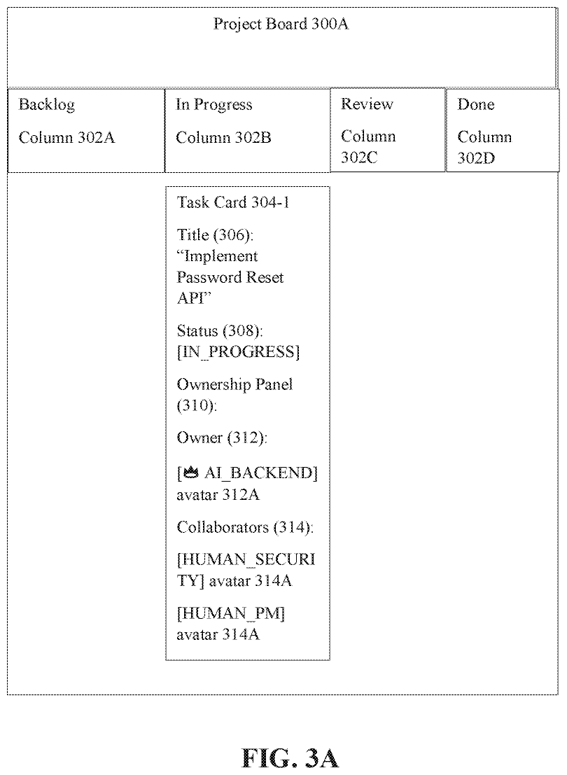

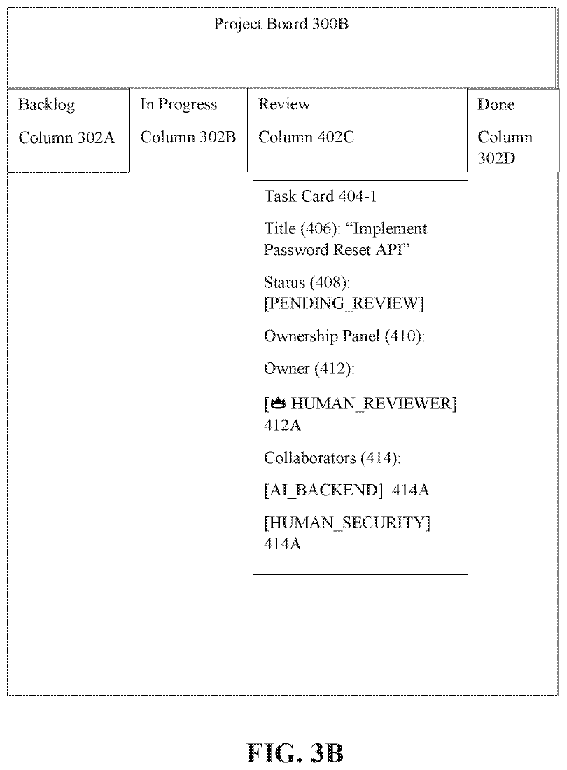

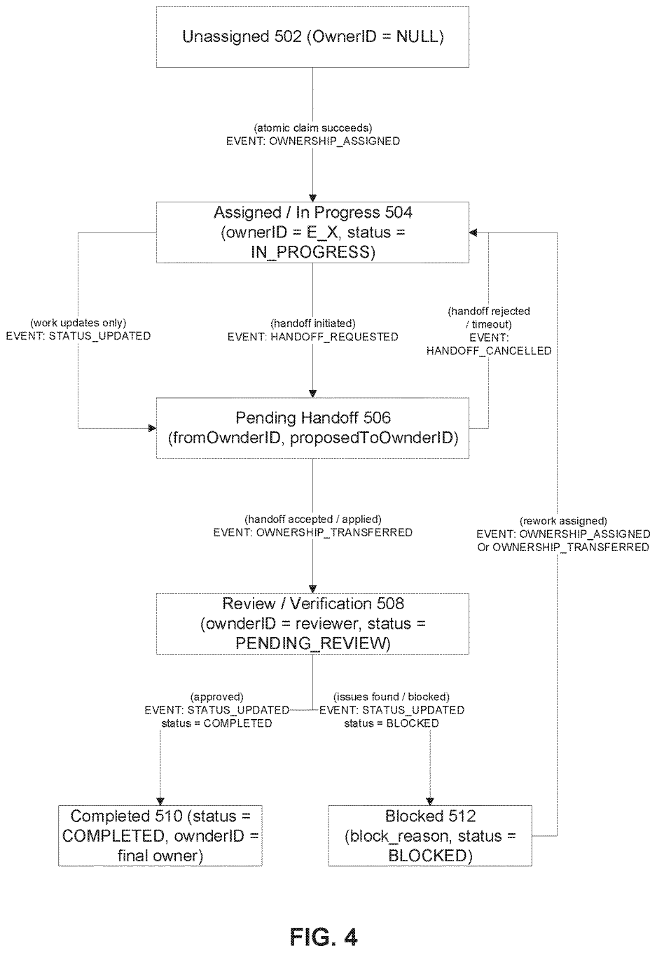

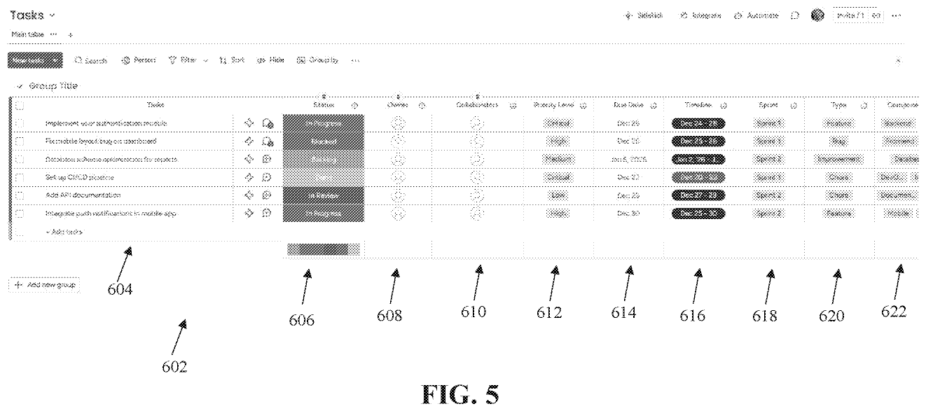

Reference is now made to FIG. 1, which is a block diagram of a system for project board-based orchestration of entities on a project, in accordance with some embodiments of the present invention. Reference is also made to FIG. 2, which is a flowchart of a method of project board-based orchestration of entities on a project, in accordance with some embodiments of the present invention. Reference is also made to FIG. 3A, which is a schematic of an example project board depicting granular tasks, assigned owners, and collaborators prior to an ownership handoff, in accordance with some embodiments of the present invention. Reference is also made to FIG. 3B, which is a schematic of the project board of FIG. 3A following execution of an ownership handoff via an atomic ownership protocol engine, in accordance with some embodiments of the present invention. Reference is also made to FIG. 4, which is a state diagram illustrating an ownership-handoff state machine for granular tasks as implemented by the atomic ownership protocol engine and the event-sourced state ledger, in accordance with some embodiments of the present invention. Reference is also made to FIG. 5, which is a schematic of another exemplary project board, in accordance with some embodiments of the present invention.

System 100 may implement the acts of the method(s) described herein, for example described with respect to one or more other Figures, by processor(s) 102 of a computing environment 104 executing code instructions (e.g., code 106A) stored in a memory 106.

Computing environment 104 may be implemented as, for example, one of more of: a server, a computing cloud, a virtual server, and the like. Computing environment 104 may include a single computing environment, and/or a group of computing environments arranged in parallel.

Client terminal(s) 112 access code of one or more project board(s) 116C (e.g., interactive user interfaces and/or GUI) stored and/or managed by computing device 104. Project board(s) 116C may be presented on a user interface 108 (e.g., display) associated with client terminal(s) 112. Client terminal(s) 112 may be implemented, for example, a desktop computer, a mobile device, a smartphone, a laptop, a tablet computer, a wearable computing device, a glasses computing device, and a watch computing device.

Computing environment 104 includes one or more processor(s) 102, implemented as for example, central processing unit(s) (CPU), graphics processing unit(s) (GPU), field programmable gate array(s) (FPGA), digital signal processor(s) (DSP), application specific integrated circuit(s) (ASIC), customized circuit(s), processors for interfacing with other units, and/or specialized hardware accelerators. Processor(s) 102 may be implemented as a hardware processor. Processor(s) 102 may be implemented as a single processor, a multi-core processor, and/or a cluster of processors arranged for parallel processing (which may include homogenous and/or heterogeneous processor architectures). It is noted that processor(s) 102 may be designed to implement in hardware one or more features stored as code instructions 106A.

Memory 106 stores code instructions executable by processor(s) 102, for example, a random access memory (RAM), dynamic random access memory (DRAM) and/or storage class memory (SCM), non-volatile memory, magnetic media, semiconductor memory devices, hard drive, removable storage, and optical media (e.g., DVD, CD-ROM). Storage device 106 stores, for example, code 106A that when executed by processor(s) 102, implements one or more features and/or acts of the methods described herein.

Computing environment 104 may include a data storage device 116 for storing data, for example, granular task repository 116A set for storing the generated granular tasks and associated data, engine(s) and/or LLM(s) 116B as described herein, and code of project board 116C, and/or other data described herein. Data repository 116 may be implemented as, for example, a memory, a local hard-drive, virtual storage, a removable storage unit, an optical disk, a storage device, and/or as a remote server and/or computing cloud (e.g., accessed using a network connection).

Computing environment 104 may include a network interface 118 for connecting to network 114, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 114 may be implemented as, for example, the internet, a local area network, a virtual private network, a wireless network, a cellular network, a local bus, a point to point link (e.g., wired), and/or combinations of the aforementioned.

Computing environment 104 may connect using network 114 (or another communication channel, such as through a direct link (e.g., cable, wireless) and/or indirect link (e.g., via an intermediary computing unit such as a server, and/or via a storage device) with data source(s) 110 and/or client terminal(s) 112.

Computing environment 104 may communicate with a server(s) and/or other platform(s) 110, for example, for enabling AI-agents to autonomously claim granular tasks presented on project board 116C, for receiving the high-level user intent for implementing a project, for monitoring completion status of the granular tasks, and the like.

Examples of server(s) and/or platform(s) 110 include a project management platform, a software development repository, an external computing device, an external storage device(s) (e.g., hard drive, optical drive, computing cloud, virtual storage), a network server, a web server, a storage server, a local server, a remote server, and a computing cloud, and the like.

Computing environment 104 and each client terminal 112 may include and/or be in communication with one or more physical user interfaces 108 that include a mechanism for a view and/or interact with user interface(s) 116C. Exemplary user interfaces 108 include, for example, one or more of, a touchscreen, a display, a keyboard, a mouse, and voice activated software using speakers and microphone.

AI-agents instances and/or machine learning models described herein may be trained using training examples to generate a trained machine model capable of making inferences and/or predictions on new data, and/or for executing the granular tasks described herein. Not necessarily limiting examples of such machine learning models may include natural language processing (NLP) algorithms, such as transformer-based models (e.g., BERT, RoBERTa, and variants thereof), sequence-to-sequence models, and text embedding models; classification and regression algorithms, such as logistic regression or support vector machines; deep learning algorithms using artificial neural networks, including convolutional neural networks (CNNs) or recurrent neural networks (RNNs); topic modeling algorithms such as Latent Dirichlet Allocation (LDA); and other statistical or probabilistic models such as Bayesian networks. The training of such AI-agents may involve training, validation, and/or test examples to determine or refine parameters of the machine learning model. The trained AI-agents may be designed to perform specific tasks described herein.

Referring now back to FIG. 2, at 202, a project board is presented on a display.

The project board serves as a unified workspace where entities, including both human and AI team members operate.

In some embodiments, the project board is built on a platform designed for collaboration by AI-agent instances and human users on a project, for example, enabling dynamic assignment and/or reassignment of granular tasks of the project to different AI-agent instances and/or human users, as described herein.

Exemplary projects which may be collaborated on and presented within the project board include: software development projects, research and development projects, regulatory approval of drugs, and constructions projects.

The project board may be interactive, enabling human users and/or AI-agent instances to select and/or reassign tasks associated with the project. The tasks may be selected, for example, by touching the task on a touch screen presenting the project board, clicking on the tasks via a user interface (e.g., mouse, keyboard), analyzing speech spoken by a user into a microphone, and the like.

Ledger entries stored by an event-sourced state ledger are manage and/or present within the project board. The project board presents a real-time state of the event-sourced state ledger, providing a single source of truth that reflects the live state of all work being done. The ledger may help ensure that the granular tasks are synchronized and/or visible to humans on the project board.

An exemplary architecture is now described. It is to be understood that other architectures may be implemented. The event-sourced state ledger may be implemented for example, using an append-only data structure where each ledger entry comprises an immutable event record. The event record may include, for example, one or more of: a unique event identifier, timestamp, event type (e.g., taskcreated, ownershiptransferred, status_updated), entity identifier, task identifier, and serialized state change payload. The project board operates as a materialized view that reconstructs current task states through an event replay engine processing chronologically-ordered events via state transition functions, with real-time updates propagated through WebSocket connections or Server-Sent Events to maintain sub-second latency between ledger modifications and user interface updates. Task synchronization employs optimistic concurrency control with version-based conflict detection, where concurrent modification attempts trigger resolution protocols, while distributed consensus processes ensure consistency across multiple nodes through quorum-based event acknowledgment. The underlying storage utilizes write-optimized databases with event indexing for efficient querying by task ID, entity ID, or temporal ranges, complemented by read replicas and caching layers that serve current state queries reconstructed from events. Human visibility implements role-based access control filtering ledger entries through authenticated channels, with the immutable event structure providing complete audit trails and enabling multiple synchronized views (Kanban boards, Gantt charts, dependency graphs) derived from the same authoritative event stream without data duplication.

At 204, user intent for implementing a project, optionally a software development project, is received. The user intent may be provided at a high level (high level user intent), such as high level abstract concepts and/or objectives without necessarily providing details of the technical implementation.

The high-level user intent may be entered, for example:
Manually by a user as natural language. The user may type the intent into an interactive user interface.
Automatically by monitoring newly generated tasks indicating the intent for implementing the project.

High-level user intent may be provided as unstructured natural language input that describes, for example, project objectives, functional requirements, and/or desired outcomes without necessarily specifying technical implementation details or granular task breakdowns. This intent represents the conceptual “what” rather than the procedural “how” of project implementation. LLM may transform the abstract requirements into executable work structures.

The system may processes intent data containing varying levels of specificity, from broad conceptual statements (e.g., “build a customer management system”) to more detailed functional descriptions (e.g., “create a web application that allows sales teams to track customer interactions, generate reports, and integrate with existing email marketing tools”). The LLM described herein interprets semantic meaning, infers missing requirements, and/or identifies implicit dependencies regardless of input completeness or technical precision.

The system may implement web-based or desktop interfaces featuring text input fields, rich text editors, or conversational chat interfaces that capture user-provided natural language descriptions. Input validation mechanisms verify text completeness while natural language processing libraries (such as spaCy or NLTK) may perform preliminary linguistic analysis including tokenization, part-of-speech tagging, and named entity recognition to identify project components.

Examples of user intent entered as natural language text by a user include:
E-commerce Project Intent: “I need an online store where customers can browse products, add items to their cart, process payments securely using Stripe, and receive email confirmations. The admin panel should allow inventory management and sales reporting.”
Data Analytics Intent: “Create a dashboard that connects to our PostgreSQL database, displays real-time sales metrics with interactive charts, allows filtering by date ranges and regions, and automatically emails weekly reports to managers.”
Mobile Application Intent: “Build a fitness tracking app for iOS and Android that lets users log workouts, track progress with charts, share achievements on social media, and sync data with Apple Health and Google Fit.”

The automatic intent detection mechanism may be implemented, for example, by monitoring existing task queues, support ticket systems, and/or project management platforms to identify recurring patterns or emerging requirements that indicate new project needs. Machine learning model may analyze task metadata including, for example, descriptions, labels, assignees, and/or completion patterns to detect when accumulated work suggests a larger strategic initiative.

The system may implement clustering processes (e.g., K-means or DBSCAN) that group related tasks based on semantic similarity scores computed through for example, vector embeddings. When cluster analysis identifies task groups exceeding predefined thresholds for example, size, frequency, or strategic importance, the system generates inferred project intent statements. For example, multiple bug reports related to mobile responsiveness issues might trigger automatic generation of “Implement mobile-responsive design system” project intent.

API integrations may be implemented with customer relationship management systems, help desk platforms, or business intelligence tools enable the system to monitor external signals indicating project requirements. Webhook implementations may receive notifications when specific trigger conditions occur, such as customer feature requests reaching critical mass, performance metrics exceeding acceptable thresholds, or regulatory compliance requirements emerging from legal system updates.

Examples of automatically generated user intents include:
Support Ticket Analysis: Monitoring customer support platforms reveals 50+ requests for mobile app functionality, triggering automatic generation of “Develop mobile application for customer self-service” project intent
Performance Monitoring Integration: System monitoring alerts indicating database performance degradation across multiple applications generate “Database optimization and scaling infrastructure” project intent
Business Intelligence Triggers: Sales data analysis revealing customer churn patterns in specific market segments creates “Customer retention platform for enterprise accounts” project intent

At 206, the high-level user intent may be automatically transformed into multiple granular tasks designed for execution by entities, which may include human and/or AI-agent instances. Each granular task may be represented as an item on the project board. The granular task may represent the smallest unit of the project that is individually represented on the project board.

The high-level user intent may be automatically transformed into the granular tasks by a large language model (LLM). The LLM may be trained on datasets of sample user intents and corresponding granular tasks (e.g., as ground truth) in the domain of the current project.

The LLM and/or other processes (e.g., other AI-agents) may perform preprocessing, for example, normalizing text formatting, correcting spelling errors using probabilistic models, and/or segmenting input into logical requirement blocks. The LLM and/or other semantic analysis engines may extract functional requirements, identify technical constraints, and/or infer unstated dependencies based on best practices and/or domain knowledge.

Each granular task may include at least one or more or all of the following data:
Task ownership assignment: indicating who the owner of the granular task is. The owner may assign the task to another entity, and/or change status flags of the task such as to ‘done’.
Task description: A description of the task. The task description may be implemented in a format suitable for an AI-agent to analyze and/or process the task, for example, an encoding, values of predefined fields, and a natural language description. The AI-agent may autonomously select granular tasks having task descriptions that are suitable for the design of the AI-agent. The task description may be provided in natural language to help a human understand the task.
Dependency relationships: indicating how the current granular task is dependent on other granular tasks. Dependency relationships include internal dependencies (e.g., steps within a single task, like Code to Review) and/or external dependencies (e.g., Task B cannot start until Task A finishes). In another example, the current granular task is dependent on data generated by a preceding granular task. In yet another example, data generated by the current granular task is fed into a subsequent granular task. The dependency relationships may be implemented as, for example, a directed acyclic graph (DAG), pointers, tags, and the like.
Completion status (also referred to herein as task status): indicating, for example, what was completed, when it was completed, projected time and/or date for completion, and whether the task is still pending and not yet complete.
Allocated resources for executing the granular task: for example, time by supporting entities, database storage space, allocated processor utilization, and the like.

Optionally, the LLM analyzes (e.g., complex) project requirements generated in response to the high-level user intent, and automatically generates the granular tasks with defined acceptance criteria and deliverable specifications. For example, the LLM processes product requirement documents and/or project descriptions through natural language analysis, to create actionable granular tasks with appropriate skill requirements and/or resource allocations.

An example is now provided, where the high-level user intent is “Create a customer review system for our e-commerce website where users can rate products, write reviews, view other customers' feedback, and where administrators can moderate inappropriate content.” The LLM may employ named entity recognition to identify functional components (e.g., users, products, reviews, ratings, and/or administrators) and/or actions (e.g., rate, write, view, and/or moderate). Based on software development patterns, the LLM infers required components including database schema, user interface elements, backend API endpoints, authentication systems, and content moderation workflows. The LLM applies logical sequencing rules determining that database tables must precede API endpoints, user authentication must precede review submission, and review display requires data retrieval mechanisms. The LLM may generate the following granular tasks:
Database Task: “Design reviews table schema with review_id, product_id, user_id, rating (1-5), review_text, timestamp, moderation_status columns”—assigned capability requirements: database_design, SQL—no dependencies
API Implementation: “Implement POST/api/reviews endpoint with JSON validation, authentication enforcement, database insertion”—capabilities: backend_development, REST_API—depends on database task
Frontend Component: “Create React ReviewForm component with star rating selector, text input, form validation, API integration”—capabilities: frontend_development, React—depends on API task
Admin Interface: “Build moderation dashboard with review approval/rejection controls, search functionality”—capabilities: admin_interfaces, frontend_development—depends on API tasks

At 208, the event-sourced state ledger is populated with the granular tasks as the ledger entries.

The event-sourced state ledger may implement granular task population, for example, through structured ledger entries containing immutable task objects serialized as JSON with mandatory fields including unique task identifiers (UUID v4), executable task descriptions, capability requirement arrays, dependency relationships encoded as directed graph adjacency lists, entity ownership assignments, completion status enumerations (CREATED, ASSIGNED, INPROGRESS, COMPLETED, BLOCKED), and metadata containing effort estimates and timestamps. Task creation events may be appended to the ledger in dependency-resolved order through atomic batch transactions that maintain referential integrity, with topological sorting algorithms ensuring prerequisite tasks are created before dependent tasks while circular dependency detection prevents unresolvable execution cycles. The underlying storage utilizes write-optimized databases (Cassandra/DynamoDB) with composite partition keys (projectid, task_id) and secondary indexes on status and entity fields, implementing 3-node replication with eventual consistency and real-time event propagation through streaming infrastructure (Kafka/Kinesis) to synchronize project board interfaces and capacity optimization schedulers. Comprehensive validation mechanisms enforce JSON schema compliance, verify capability requirements against system taxonomies, validate dependency graph acyclicity through topological analysis, and implement input sanitization to prevent injection attacks while maintaining data integrity through checksum verification of task payloads.

In an exemplary implementation, each granular task is represented in the event-sourced state ledger as a JSON document with required fields for identifiers, dependencies, ownership, status, priority, and linked artifacts. An example schema instance may be implemented as:
{
“taskId”: “T-12345”,
“projectId”: “P-ACME-WEB”,
“title”: “Implement password reset API endpoint”,
   “description”: “Create POST/api/password-reset with token validation and audit logging.”,
   “ownerId”: “E_AI_BACKEND”,
   “participants”: [“E_HUMAN_SECURITY”, “E_AI_QA”],
   “dependencies”: [“T-12340”, “T-12341”],
   “status”: “IN_PROGRESS”,
   “priorityScore”: 0.92,
   “capabilityVector”: {
      “python”: 0.9,
      “rest_api”: 0.95,
      “security”: 0.7
   },
   “allocatedResources”: [
      {“type”: “build_runner”, “resourceId”: “runner-5”, “leaseId”: “L-789”},
      {“type”: “repo_write_token”, “resourceId”: “git-token-42”, “leaseId”: “L-790”}
   ],
   “linkedArtifacts”: {
      “repository”: “git@github.com:acme/webapp.git”,
      “branch”: “feature/password-reset”,
      “pullRequestUrl”: “https://github.com/acme/webapp/pull/321”,
      “ciJobUrl”: “https://ci.example.com/jobs/98765”
   },
   “createdat”: “2025-01-01T10: 00:00Z”,
   “updatedAt”: “2025-01-01T10: 05:12Z”,
   “version”: 3
}

The event stream for this task then consists of immutable events (e.g., TASK_CREATED, OWNERSHIP_ASSIGNED, STATUS_UPDATED, PRIORITY_REC ALCULATED, RESOURCE_LEASE_GRANTED/REVOKED) whose payloads update or enrich these fields when materialized into the current state view used by the project board.

In some embodiments, one or more guardrails may be enforced around task and/or event mutations. For example, role-based access control (RBAC) may be used to ensure that authorized principals (e.g., specific human roles and/or AI-agents) can perform privileged operations such as ownership transfer, status changes to “COMPLETED,” and/or deployment-related actions, with permissions checked on every API call. Incoming task and/or event payloads may be validated against a schema (for example, using JSON Schema) so that required fields (e.g., task identifiers, owner identifiers, status enums, dependency lists, and resource references) and/or value ranges may be enforced before events are appended. Dependency relationships supplied for new and/or updated tasks may be checked for acyclicity, for example, by running a DAG validation (e.g., topological sort or cycle-detection algorithm). Circular dependencies may be rejected and not committed to the ledger. Optionally, accepted mutations (e.g., TASK_CREATED, OWNERSHIP_ASSIGNED, STATUS_UPDATED, HANDOFF_REQUESTED, RESOURCE_LEASE_GRANTED/REVOKED) may be written to an append-only audit log with timestamp, actor identity, prior and/or new values, and/or correlation identifiers, enabling full traceability, regulatory compliance review, and/or post-incident forensics.

Optionally, a priority score is computed per granular task, optionally for each granular task. The priority score may be used for autonomous selection and/or executing of tasks by AI-agent instances operating in parallel. For example, AI-agent instances may scan the granular tasks, and automatically select granular tasks with highest priority scores prior to selection of granular tasks with lower priority scores. In another example, AI-agent instances may select granular tasks with scores exceeds a threshold. Alternatively or additionally, the priority score may be used for automatic assignment of granular tasks to entities, for example, by a capacity optimization scheduler and/or orchestrator process described herein.

The priority score may be computed for each task as a function of and/or based on one or more of:
Dependency relationships (e.g., represented by a task dependency graph state, optionally implemented as a directed acyclic graph): Tasks which have multiple other tasks dependent on them may be assigned higher scores than other tasks which have fewer or no other tasks dependent on them.
An entity capability similarity metric: Each task (e.g., task description) may be compared to a capability profile of each available entity, for example, computing a correlation between requirements of the task and capabilities of the available entity. Entities with a higher similarity metrics may be assigned a higher priority metric than entities with lower similar metrics.
Complexity metrics: More complex tasks, which may take more time to complete and/or may require more allocated and/or specialized capabilities by entities, may be assigned higher priority than simpler tasks.
Resource availability: Tasks which require resources that are less available, such as a shared resource in limited supply with a queue of waiting tasks, may be assigned a higher priority over tasks which can be performed with more available resources.

At 210, granular tasks may be allocated to entities, by assigning the entities as owners. The assignment of granular tasks to entities may be performed, for example:
Manually by humans selecting the granular tasks from the project board using the interactive interface of the project board.
Autonomously by AI-agents, such as based on the task description and/or priority score. The AI-agents may query the project board to find and claim the granular tasks.
Automatically by code that matches the granular tasks to entities, such as based on capabilities and/or capacity, as described herein.
By the capacity optimization scheduler described herein.

In some embodiments, for each granular task that can be performed in accordance with its dependency relationship, the system enforces assignment of an owner that is granted permission to change the status of the granular task and/or for enabling the owner to attend to the task (i.e., work on the task) according to the task description. In some embodiments, the current owner is responsible to complete the granular task and/or change the completion status of the granular task to reflect completion (or reflect another current status such as in progress). A granular task's dependencies may be considered as being satisfied when prerequisite tasks (e.g., all tasks) upon which the granular task depends have been marked as completed, enabling the granular task to be executed by its assigned owner. Until dependencies are satisfied, the granular task may remain in a blocked and/or pending state, preventing premature execution that would fail due to unavailability of required inputs, data, and/or deliverables from prerequisite tasks.

Optionally, unassigned granular tasks are allocated to entities.

Alternatively, granular tasks currently assigned to entities may be planned to be reassigned to other entities. For example, as part of a resource rebalancing process. In some embodiments, the reassignment may be planned, but not yet executed, where the reassignment is performed as a handoff using an atomic ownership protocol to prevent concurrent execution of the granular tasks.

Maintenance tasks may be automatically identified. The identified maintenance tasks may be automatically assigned to appropriate entities based on capability matching and workload optimization. For example, new bug reports ingested from an external issue tracker (e.g., JIRA, GitHub Issues) may be converted into granular tasks with ownership assigned to an AI-agent and/or human developer having relevant domain expertise. In another example, static code analysis tools may generate findings indicative of technical debt (e.g., security warnings, code smells, dependency vulnerabilities), which may be automatically transformed into refactoring and/or remediation tasks, which may be routed to entities with appropriate refactoring and/or security capabilities. In some embodiments, selected maintenance tasks are delegated to third-party agent executors exposed via APIs (e.g., external code-fixing services or automated remediation platforms), with the atomic ownership protocol treating such third-party services as entities with corresponding entity identifiers.

In some embodiments, the system may automatically generate and maintain perpetual and/or cyclical tasks. For example, recurring reporting tasks such as “generate sprint summary and velocity report every two weeks” or “prepare quarterly budget allocation and capacity forecast” may be instantiated as granular tasks on a fixed cadence, each time assigned to one or more entities (e.g., a finance AI-agent, a project-management AI-agent, or designated human stakeholders), optionally according to capability profiles and/or current workload.

Assignments of granular tasks to entities (i.e., AI-agent instances and/or humans) may be dynamically rebalanced, optionally in real-time, optionally by the capacity optimization scheduler.

In some embodiments, the capacity optimization scheduler may treat each granular task as a resource-constrained job with capability vectors and/or deadline constraints. The capability vector may indicate the capabilities that the entity which is to work on the task is required to possess in order to complete the task. For example, a coding task requires a software developer with coding skills. The deadline constraints may indicate the time and/or date for completion of the task. Entities with capacity to handle the task prior to the deadline may be assigned to the task.

An exemplary implementation is now described. The capacity optimization scheduler may implement a multi-dimensional resource allocation process that models each granular task as a resource-constrained job containing capability vectors encoded as normalized floating-point arrays where each dimension corresponds to specific technical competencies (e.g., Python: 0.9, SQL: 0.8, React: 0.7) with values from 0.0 to 1.0 representing required proficiency levels. Entity capability profiles are maintained through historical task completion analysis and performance metrics, with task-entity matching computed using cosine similarity: similarityscore=(entityvector·taskvector)/(||entityvectorμ×∥task_vectorμ), where scores above predetermined thresholds (typically 0.7) indicate suitable capability alignment. Deadline constraints are processed using critical path method calculations on dependency graphs to determine latest allowable start times, with time-critical tasks receiving exponentially increasing priority multipliers in the assignment algorithm. The scheduler employs integer linear programming to solve multi-objective optimization problems that maximize capability utilization while minimizing deadline violations and workload imbalances across entities, continuously rebalancing assignments through event-driven updates when entity availability changes, tasks complete ahead of schedule, or new dependencies resolve, maintaining optimal resource allocation with sub-second response times across dynamic project environments.

The rebalancing of assignments may be performed according to the capability vectors and/or deadline constraints of the granular tasks, in view of available entities, available resources, and/or the deadline constraints.

The capacity optimization scheduler may operate across multiple projects, for dynamically rebalancing the assignments across the multiple projects. For example, when entities are working on granular tasks of different projects, similar granular tasks may be assigned to the same entity.

The capacity optimization scheduler may automatically allocate resources (e.g., shared resources) on a granular task level.

The capacity optimization scheduler may operate across multiple projects, for dynamically allocated resources on a project level, by assigning a portion of the total available resource capacity to a particular project as a whole (for example, a specific software product, service, or epic that is represented by a project board), before those resources are further subdivided and scheduled among individual granular tasks within that project. For example, the scheduler may grant Project A a pool of (i) five concurrent CI build runner slots, (ii) two production deploy slots per hour, and (iii) a repository write token scoped to Project A's Git repository; Project B may receive a different pool sized according to its priority, deadlines, and historical utilization. The resources allocated to each project may then be allocated on the granular task level. For example, such that particular tasks within Project A (e.g., “Run integration tests,” “Build Docker image,” “Deploy to staging”) obtain time-limited leases on specific resources from the project's pool.

In some embodiments, resource access is managed via explicit lease semantics enforced by the capacity optimization scheduler and recorded in the event-sourced state ledger. When a granular task requires a repository write token to push a branch, or a build runner to execute a CI job, or a deployment slot to update a staging environment, the scheduler issues a RESOURCELEASEGRANTED event that associates the resource identifier (e.g., repowritetoken123, buildrunner5, deployslotstaging1) with the task identifier and an expiration time. During the lease, only the owning task's entity may exercise write or execution privileges using that resource; other entities attempting to claim the same resource for overlapping intervals receive a denial and may either queue or be reassigned. Upon task completion, timeout, or explicit cancellation, the scheduler appends a RESOURCELEASEREVOKED or RESOURCELEASEEXPIRED event, revoking access and returning the resource to the project-level pool for reassignment. This leasing and revocation mechanism may span multiple projects, allowing the scheduler to dynamically shift unused capacity (e.g., idle build runners or unused deploy slots) from lower-priority projects to higher-priority projects, while still enforcing that, at any given moment, a leased resource is bound to at most one granular task and hence cannot be a source of conflicting concurrent operations.

The capacity optimization scheduler may automatically assign the entities (human and/or AI-agent instances) to granular tasks based on the computed priority scores and/or based on the capability profiles of the entities.

At 212, granular tasks assigned to current owners are handed-off to other owners. The handoff may be triggered in response to a monitoring of completion status of the granular tasks. A change in status of a granular task to complete may trigger the handoff.

In some embodiments, the system is designed to manage the seamless switching of responsibilities of owners to granular tasks, by managing the handoff.

In some embodiments, the handoff of the granular tasks(s) is performed according to an atomic ownership protocol engine that executes atomic claim-work-handoff transactions designed for preventing concurrent execution conflicts between tasks between two or more entities attempting to simultaneously execute the same granular task.

In some embodiments, the atomic ownership protocol engine may be further designed to deny the resources allocated to the granular task with access to change the status of the granular task. Preventing the allocated resources from changing the status of the granular task helps prevent execution conflicts.

In some embodiments, the atomic ownership protocol engine may implement a distributed consensus mechanism that executes claim-work-handoff transactions using database-level atomic operations with ACID (Atomicity, Consistency, Isolation, Durability) properties to ensure exactly-one-owner semantics for each granular task at any given time. The protocol may employ compare-and-swap (CAS) operations at the database layer, where task ownership changes require verification that the current ownership state matches the expected state before applying modifications, preventing race conditions when multiple entities attempt simultaneous task claiming or handoff operations. Each ownership transaction may be encapsulated within database transaction boundaries using two-phase commit protocols that first acquire exclusive locks on task records, verify preconditions including entity capability requirements and dependency satisfaction, then atomically update ownership assignment fields with new entity identifiers and transition timestamps.

In some embodiments, atomic task claiming and/or handoff operations are exposed via an API that requires a version or concurrency token with each write. For example, an AI-agent may issue a REST request such as POST/tasks/{taskId}/claim with body {“newOwnerId”: “E_AI_BACKEND”, “expectedVersion”: 17}. The server-side ownership protocol reads the current task row (e.g., owner_id, status, version), and performs an atomic compare-and-swap at the storage layer such as:
UPDATE tasks
   SET owner_id=: newOwnerId,
      status=‘IN_PROGRESS’,
      version=version+1
WHERE task_id=: taskId
   AND version=: expectedVersion;
or, in a document store:
db.tasks.updateOne(
   {taskId: “<id>”, version: 17} ,
   {$set: {ownerId: “E_AI_BACKEND”, status: “IN_PROGRESS”} ,
      $inc: {version: 1}}
);

If the update affects zero rows/documents, the claim fails due to a concurrent modification, and the agent receives a conflict response (e.g., HTTP 409) and may retry with backoff. Handoff is implemented similarly (e.g., POST/tasks/{taskId}/handoff with expectedVersion and nextOwnerId), ensuring that ownership transfers and status updates succeed only when the task is in the expected prior state, thereby enforcing atomic, conflict-free transitions recorded as corresponding ledger events.

In some embodiments, the system may implement optimistic concurrency control using version numbers or timestamps as conflict detection mechanisms, where each task record maintains a version field that increments with every ownership change operation. Entity attempts to claim or modify task ownership must include the expected version number in their transaction request, with the database rejecting operations where version numbers indicate concurrent modifications have occurred. When conflicts are detected, the system may implement, for example, exponential backoff retry mechanisms with jitter to prevent thundering herd scenarios, while maintaining fairness through randomized retry delays that prevent systematic entity prioritization. Deadlock prevention processes may analyze dependency graphs to detect potential circular wait conditions and implement timeout mechanisms that automatically release locks after predetermined intervals to ensure system liveness.

In some embodiments, the handoff is to a next entity in a dependency chain dictated by the dependency relationships of the granular tasks (internal and/or external). The handoff may be to the next entity which has been previously selected to be the next owner assigned to the task. For example, Assign Entity 1 to Task A (Code)->Hand to Entity 2 (Task A, Review)->Hand to Entity 3 (Task B, Design).

In some embodiments, the atomic protocol may maintain transaction logs recording ownership change attempts including successful commits and/or failed operations with detailed error codes indicating specific failure reasons (version conflicts, capability mismatches, dependency violations, timeout conditions). Rollback mechanisms may implement compensation transactions that reverse partial state changes when multi-step handoff operations fail mid-execution, ensuring the system returns to consistent states without orphaned task assignments or invalid dependency relationships. The protocol may implement write-ahead logging where all ownership changes are persisted to immutable transaction logs before updating task state tables, enabling point-in-time recovery and audit trail maintenance for compliance and debugging purposes.

In another example, an AI-agent can complete a code migration task, update the granular task's status to “Pending Review,” and automatically reassign ownership to a specific human engineer for review. Conversely, a human can review the work, identify an issue, and reassign the granular task back to an AI-agent with new instructions.

At 214, the event-sourced state ledger may be updated according to the assignment and/or handing-off of the granular tasks.

One or more task dependency graphs that prevent task execution conflicts and/or ensure prerequisite completion before dependent task initiation are maintained, and dynamically updated as project scope changes and/or as tasks are dynamically reassigned. Priority scores of affected granular tasks may be re-computed based on the updated task dependency graphs.

Audit trails of ownership changes and/or task modifications may be maintained.

Upon completion of the selected granular tasks, a handoff event that deterministically reassigns ownership for review may be appended. The handoff event may be accompanied with context about the work done by the current owner.

At 216, the presentation of the project board on the display may be updated according to the updated event-sourced state ledger. The updated project board presents the updated states of the granular tasks, reflecting the changes in ownership.

The project board may present progress made on granular tasks, AI-generated pull requests linked directly to tasks, blockers to be resolved flagged by AI-agents, which may create a fluid, collaborative environment between entities.

At 218, one or more features described with reference to 202-216 may be iterated.

Optionally, a task-granularity refinement loop is implemented by iteratively collecting feedback regarding execution of each granular task to identify granular tasks which are to be divided into one or more child tasks. In subsequent iterations, the granular task(s) are replaced by the generated child tasks, and the child tasks are assigned and/or handed-off to entities as described herein.

In some embodiments, granular tasks to be divided may be identified, for example by: failure in execution of the granular task by the entity, complexity of execution of the granular task is above a threshold, resources to be allocated to execute the task are above another threshold, and the like. The child task(s) may be programmatically created for one or more granular tasks. The child tasks may be created as a solution to the problem of the identified granular task. For example, where execution of the granular task failed, the child task is created for increasing likelihood of success of execution. In another example, when sufficient resources cannot be allocated at once to the entity for execution of the granular task, the child task is created to require fewer allocated resources, enabling the fewer allocated resources to sequentially process a sequence of child tasks. The child task(s) may be gated by dependency graph invariants

In some embodiments, a level of granularity of the child process may be determined based on available resources. The level of granularity may indicate the number of generated child processes, interdepended between child processes, and/or complexity of each child process. The level of granularity of the child process(es) may be computed based on at least one external consideration, for example, financial resource availability, user request, designed amount of collaboration, and requirement for a human in the loop.

In some embodiments, entities are assigned according to the granularity. For example, weaker entities (e.g., less capability and/or less ability to handle complex tasks and/or associated with fewer resources) may be assigned more simple granular tasks. Stronger entities are assigned to more complex granular tasks.

Referring now back to FIG. 3A an example of a project board 300A is depicted. Project board 300A includes multiple task columns 302, for example a “Backlog” column 302A, an “In Progress” column 302B, a “Review” column 302C, and a “Done” column 302D. Each column may include one or more task cards 304, each task card 304 representing a respective granular task stored as a ledger entry in the event-sourced state ledger described herein.

Each task card 304 may include, for example, one or more of: a task title region 306 (e.g., “Implement Password Reset API”), a status indicator 308 (e.g., a color-coded badge or textual status such as “IN_PROGRESS”), and an ownership panel 310. The ownership panel 310 may visually distinguishes a single owner 312 from one or more collaborators 314. In some embodiments, the owner 312 is depicted by a graphical avatar icon 312A displayed in a dedicated “Owner” sub-region of the ownership panel 310 and marked with a visual emphasis indicator, for example, a crown icon overlaid on the avatar, a bold outline, or a distinct color. The collaborators 314 may be shown as additional avatar icons 314A in a separate “Participants” or “Collaborators” sub-region without the crown or emphasis indicator, thereby visually differentiating ownership from non-owning participation.

In the embodiment shown in FIG. 3A, a particular task card 304-1 in the “In Progress” column 302B is owned by an AI-agent entity E_AI_BACKEND (represented by avatar 312A with a crown) and has one or more human collaborators 314 (e.g., E_HUMAN_SECURITY, E_HUMAN_PM). The underlying event-sourced state ledger for task 304-1 may include fields, for example, fownerId=E_AI_BACKEND, participants=[E_HUMAN_SECURITY, E_HUMAN_PM], status=IN_PROGRESS, and a corresponding version or concurrency token, as described herein. At this point, no ownership handoff event has yet been recorded for task 304-1; the project board therefore presents the AI-agent avatar with the ownership crown in the owner position and the human avatars in non-owner positions. The visual state of FIG. 3A corresponds to the logical process steps of FIG. 2 in which the project board is being presented (step 202), granular tasks have been populated into the event-sourced state ledger (step 208), and ownership has been assigned for executable tasks (step 210), prior to any handoff operations (step 212).

Referring now back to FIG. 3B, a schematic diagram of an example project board 300B following execution of an ownership handoff via the atomic ownership protocol engine, is depicted. In FIG. 3B, elements that are functionally similar to those of FIG. 3A are referenced by like numerals, shifted by 100 where appropriate.

As shown in FIG. 3B, the same task card 404-1 that appeared in FIG. 3A as being owned by an AI-agent has now transitioned to a new ownership state as the result of a completed handoff transaction recorded in the event-sourced state ledger. For example, upon completion of implementation work by the AI-agent E_AI_BACKEND, the atomic ownership protocol engine may have appended an OWNERSHIP_TRANSFERRED event assigning ownership of the task to a human reviewer entity E_HUMAN_REVIEWER. In the user interface 400B, the ownership panel 410 of task card 404-1 now depicts avatar 412A (corresponding to E_HUMAN_REVIEWER) in the “Owner” sub-region, bearing the crown or other ownership indicator, while avatar 414A representing E_AI_BACKEND moves into the “Participants” or “Collaborators” sub-region without the crown.

In some embodiments, the transition illustrated from FIG. 3A to FIG. 3B may be animated or otherwise visually highlighted, for example by briefly animating the crown moving from the AI-agent avatar to the human avatar, or by a short highlight flash around the updated owner avatar. The column position of the card 404-1 may also change as part of the same ledger-driven update, for example moving from the “In Progress” column 302B shown in FIG. 3A to a “Review” column 402C shown in FIG. 3B, reflecting an updated status field (e.g., from IN_PROGRESS to PENDING_REVIEW) in the materialized view of the event-sourced state.

The visual change from the state depicted in FIG. 3A to the state depicted in FIG. 3B corresponds to the logical method steps of FIG. 2 in which completion status of a granular task is monitored (step 212), an atomic claim-work-handoff transaction is executed by the atomic ownership protocol engine to prevent concurrent execution conflicts (also step 212), the event-sourced state ledger is updated to record the new owner and status (step 214), and the presentation of the project board is updated in real time according to the updated ledger (step 216). The ownership icons and column placement seen in FIG. 3B thus constitute a direct projection of the immutable sequence of events stored in the event-sourced ledger.

Referring now back to FIG. 4, an exemplary and not necessarily limiting state diagram 500 illustrating an ownership-handoff state machine for granular tasks as implemented by the atomic ownership protocol engine and the event-sourced state ledger, is presented. Although FIG. 4 is illustrated as a state diagram, those skilled in the art will appreciate that the same logic may be represented as a flowchart of method steps.

In the illustrated embodiment, a granular task transitions among multiple discrete ownership-related states, for example, one or more of: an “Unassigned” state 502, an “Assigned/In Progress” state 504, a “Pending Handoff” state 506, a “Review/Verification” state 508, a “Completed” state 510, and an optional “Blocked” state 512. Each state transition is triggered by a corresponding atomic event processed by the atomic ownership protocol engine and appended to the event-sourced state ledger.

From the Unassigned state 502, a task may transition to the Assigned/In Progress state 504 when an entity successfully claims the task by issuing an atomic claim request (e.g., as described above with an API call including an expected version or concurrency token). This successful claim generates an OWNERSHIP_ASSIGNED event in the ledger, setting a non-null ownerId and updating status to IN_PROGRESS. If the compare-and-swap or version check fails due to a concurrent claim, the transition is not taken and the task remains in the Unassigned state 502 for that claimant.

While in the Assigned/In Progress state 504, the current owner performs work on the task and may emit intermediate STATUS_UPDATED events 522 (e.g., progress markers) that do not change ownership. Upon finishing its portion of the work, the owner may initiate a handoff by invoking a handoff API that specifies a target next owner and an expected version, resulting in a transition to the Pending Handoff state 506. In the ledger, this is represented by a HANDOFF_REQUESTED event 524 with fields such as fromOwnerId, proposedToOwnerId, and expectedVersion.

In some embodiments, when the proposed new owner (for example, a human reviewer or another AI-agent) or an orchestrating process accepts the handoff, the atomic ownership protocol engine performs a second atomic operation that verifies the task's current version and owner, and then appends an OWNERSHIP_TRANSFERRED event 526. This event causes a transition from Pending Handoff 506 to either the Review/Verification state 508 (for example, when the new owner is a reviewer) or back to the Assigned/In Progress state 504 (for example, when the new owner is another executor entity rather than a reviewer). The OWNERSHIP_TRANSFERRED event updates ownerId to the new owner and may also update status to PENDING_REVIEW or IN_PROGRESS accordingly.

From the Review/Verification state 508, the reviewer may either approve the work, in which case a STATUS_UPDATED event 528 transitions the task to the Completed state 510 (status=COMPLETED, with ownership optionally remaining with the reviewer or reassigned), or may reject the work or identify issues, in which case a STATUS_UPDATED event may transition the task to the Blocked state 512 with an associated block_reason. From the Blocked state 512, the task may transition back to Assigned/In Progress 504 (e.g., for rework by an AI-agent or a different entity) via another OWNERSHIP_ASSIGNED or OWNERSHIP_TRANSFERRED event 530, potentially after creation of one or more child tasks as described herein.

The state diagram 500 may capture, at a logical level, the ownership-handoff loop described in FIG. 2: tasks are created and initially unassigned (steps 206-208), claimed and worked on by an owner (step 210), transitioned into handoff and review states through atomic claim-work-handoff transactions (step 212), recorded as immutable events in the event-sourced state ledger (step 214), and reflected back into the project board user interface as updated task positions and ownership indications (step 216). The explicit state-machine representation of FIG. 4 emphasizes that, at any point in time, each granular task may have exactly one owner (or is unassigned), and all ownership changes may occur via atomic, version-checked transitions that prevent conflicting concurrent executions by multiple entities.

Referring now back to FIG. 5, another exemplary project board 602 is presented. Project board 602 may include rows, where each row represents a granular task 604. Project board 602 may include columns 606-622 associated with each task, for example, a status indicator 606, an owner 608, collaborators 610, priority level 612, due date 614, timeline 616, sprint 618, type 620, and component 622.

Some examples that trace the event-sourced ledger and atomic ownership-handoff loop are now provided. Each example references the features of FIG. 2 (202-216) and shows (i) the sequence of ledger events and/or (ii) ownership transitions. The examples below show how, across different workflows (feature implementation, bug/tech-debt remediation, and PRD/epic decomposition), the system of FIG. 1 and the method of FIG. 2 may operate iteratively:
Board/UI+intent capture (202, 204)
LLM-based decomposition and ledger population (206, 208)
Ownership assignment/claim (210) via atomic protocol
Work+status updates+handoff (212, 214)
Board refresh and user-visible progress (216)
all recorded as an immutable sequence of events in the event-sourced state ledger with conflict-free, precisely-defined ownership at every step.

### Example 1

### AI Implementation→Human Review→AI Rework

Scenario: User asks for a new “password reset flow” feature. An AI-agent implements it, a human reviews, and an AI-agent performs rework.
1. High-level intent and task creation
   At 204, the user enters high-level intent: “Add a password reset flow to the web application with email-based verification and audit logging.”
   At 206, the LLM decomposes this into granular tasks, for example:
      T1: “Design password reset API schema”
      T2: “Implement password reset backend endpoint”
      T3: “Implement password reset frontend page and form”
      T4: “Security review of password reset flow”
   At 208, TASK_CREATED events are appended to the event-sourced state ledger for T1-T4, including initial owner_id=NULL, dependency edges (e.g., T2 depends on T1, T3 depends on T2, T4 depends on T2 and T3), and status=CREATED.
2. AI-agent claims and implements backend (atomic claim)
   At 210, an AI-agent entity E_AI_BACKEND scans the ledger for ready tasks. It sees T2 now unblocked after T1 is completed (by another entity) and issues an atomic claim.
   The atomic ownership protocol engine executes a OWNERSHIP_ASSIGNED event for T2:
      Previous owner: NULL→new owner: E_AI_BACKEND
      Version check/CAS succeeds; ledger records status=IN_PROGRESS.
   At 212, while working, E_AI_BACKEND updates the ledger with intermediate STATUS_UPDATED events (e.g., “code generated”, “tests run”).
   Upon successful implementation, E_AI_BACKEND appends a STATUS_UPDATED event for T2 marking status=COMPLETED.
   Still at 212, the AI-agent triggers a handoff by appending a HANDOFF_REQUESTED event for T4 (“Security review of password reset flow”) with proposed next owner E_HUMAN_SECURITY, and the atomic engine converts that into an OWNERSHIP_TRANSFERRED event for T4 once accepted.
3. Human security review and ownership transfer back to AI for rework
   At 214, the ledger reflects that T4's owner is now E_HUMAN_SECURITY and status=IN_PROGRESS.
   The human reviewer discovers an issue (e.g., missing rate-limiting) and appends:
      A STATUS_UPDATED event on T4: status=BLOCKED, block_reason=“Missing rate limiting on reset endpoint”.
      A new granular task T5: “Add rate limiting to password reset backend endpoint,” causing a TASK_CREATED event with dependency on T2, owner_id=NULL, status=CREATED.
   At 210 again, E_AI_BACKEND atomically claims T5, causing OWNERSHIP_ASSIGNED for T5 (NULL→E_AI_BACKEND), followed by STATUS_UPDATED events as it implements rate limiting, and then status=COMPLETED for T5.
   The completion of T5 automatically triggers a HANDOFF_REQUESTED event from E_AI_BACKEND back to E_HUMAN_SECURITY for T4 review, and the atomic engine appends OWNERSHIP_TRANSFERRED for T4 (owner: E_AI_BACKEND or NULL →E_HUMAN_SECURITY), with T4 set to IN_PROGRESS.
4. Final approval and board update
The human reviewer confirms remediation, appends STATUS_UPDATED for T4: status=COMPLETED.
   At 214, the ledger now shows T2-T5 completed, and the dependency graph marks the feature chain complete.
   At 216, the project board UI is updated: T2, T4, T5 cards move to “Done,” ownership badges show final responsible entities, and an audit trail of each task_created, ownership_assigned/transferred, and STATUS_UPDATED event is visible in the task history.

### Example 2

### Bug/Tech-Debt Intake→AI Fix→Human Verification

Scenario: A bug is imported from an external tracker; static analysis reveals additional tech debt; tasks are assigned and handed off through the ledger.
1. Bug intake from external issue tracker
   At 204, the system automatically detects a new bug “Checkout page crashes on discount code apply” from an external issue tracker (e.g., JIRA). This is treated as high-level intent for a small project or sub-project.
   At 206, the LLM/agent pipeline converts this into granular tasks:
      B1: “Reproduce checkout crash on discount apply”
      B2: “Identify root cause in discount application logic”
      B3: “Implement fix and regression tests”
      B4: “Human verification and release approval”
   At 208, the ledger is populated via TASK_CREATED events for B1-B4 with dependencies (e.g., B2 depends on B1, B3 on B2, B4 on B3) and initial owner_id=NULL.
2. AI-agent performs diagnosis and fix
   At 210, an AI QA agent E_AI_QA atomically claims B1 (OWNERSHIP_ASSIGNED: NULL→E_AI_QA, status=IN_PROGRESS) and records reproduction steps. Upon success, it sets B1 to COMPLETED (STATUS_UPDATED) and triggers a HANDOFF_REQUESTED event for B2 to E_AI_BACKEND.
   The atomic ownership engine executes OWNERSHIP_TRANSFERRED on B2 (new owner=E_AI_BACKEND), with status=IN_PROGRESS.
   E_AI_BACKEND identifies a null pointer in discount calculation, appends detailed context, sets B2 to COMPLETED, and atomically claims B3 via OWNERSHIP_ASSIGNED for B3.
   B3 is implemented and tested; STATUS_UPDATED marks B3 as COMPLETED. At 212, E_AI_BACKEND triggers
      a HANDOFF_REQUESTED to E_HUMAN_LEAD for B4 (release approval), which becomes OWNERSHIP_TRANSFERRED on B4.
3. Tech-debt detection from static analysis and assignment to external executor
   During B 3 execution, at 210/212, the system receives static analysis output from an external tool (e.g., SonarQube) indicating recurring code duplication and a deprecated discount library.
   At 208, these findings are converted into tech-debt tasks:
      D1: “Refactor duplicated discount calculation logic”
      D2: “Migrate deprecated discount library to supported version” with TASK_CREATED events, owner_id=NULL.
   At 210, the capacity optimization scheduler identifies that these are suitable for a third-party automated remediation service E_3P_REFACTOR (modeled as an entity). It atomically assigns:
      Ownership_assigned for D1 and D2 to E_3p_refactor, Status=IN_PROGRESS.
   The third-party service completes refactoring and migration, appending STATUS_UPDATED events (with remediation diffs in payloads) and marking D1 and D2 as COMPLETED. For each, it triggers HANDOFF_REQUESTED events
      to E_HUMAN_LEAD or E_AI_QA for verification, which the atomic engine resolves to OWNERSHIP_TRANSFERRED events.
4. Human verification and board update
   At 214, the ledger reflects all bug-fix and tech-debt tasks completed or pending final verification.
   E_HUMAN_LEAD performs final checks for B4, sets B4 to COMPLETED via STATUS_UPDATED.
   At 216, the project board view shows:
      Bug B1-B4 chain fully completed, with visualized handoffs from AI to human.
      Tech-debt tasks D1 and D2 completed with ownership history indicating the external executor and follow-up verification owners.
   The linked event history provides a complete, immutable audit of bug intake→AI diagnosis→AI/third-party fix→human approval.

### Example 3

### Product Requirements Document (PRD)/Epic Decomposition

Scenario: A product manager uploads a PRD for a “Team Analytics Dashboard” epic. The system decomposes it into granular tasks, sequences ownership, and coordinates AI and human roles.
1. Prd Ingestion and Decomposition
   At 204, the product manager provides high-level intent via a PRD file and/or natural language: “Build a team analytics dashboard showing weekly active users, feature adoption, and error rates, with filters by team and time range.”
   At 206, the LLM processes the PRD and generates granular tasks such as:
      P1: “Define analytics data model and metrics”
      P2: “Create backend aggregation jobs and APIs for metrics”
      P3: “Design dashboard UX wireframes”
      P4: “Implement frontend dashboard components”
      P5: “QA validation and usability review”
   At 208, TASK_CREATED events are appended for P1-P5 with dependency graph (e.g., P2 depends on P1, P4 depends on P2 and P3, P5 depends on P4), and owner_id=NULL. The ledger stores acceptance criteria and deliverables parsed from the PRD as part of the task payloads.
2. Initial ownership assignments (automatic+manual)
   At 210, the capacity optimization scheduler evaluates capability vectors and workload:
      Assigns P1 to E_HUMAN_PM (product manager) via OWNERSHIP_ASSIGNED (NULL→E_HUMAN_PM).
      Assigns P3 to E_HUMAN_DESIGNER.
   E_HUMAN_PM completes P1 (metrics definition), appending STATUS_UPDATED (P1: COMPLETED), and triggers a HANDOFF_REQUESTED event for P2 to E_AI_DATAENG. The atomic engine records OWNERSHIP_TRANSFERRED for P2.
   E_HUMAN_DESIGNER completes P3, marks it COMPLETED, and triggers HANDOFF_REQUESTED for P4 to E_AI_FRONTEND.
3. AI implementation and coordinated handoff to QA/stakeholders
   E_AI_DATAENG (owner of P2) generates aggregation jobs and APIs, recording incremental STATUS_UPDATED events and finally marking P2 as COMPLETED.
   E_AI_FRONTEND (owner of P4) waits for P2 and P3 dependencies to be fulfilled (checked via dependency graph at 210/212), then claims P4 (OWNERSHIP_ASSIGNED) and implements the dashboard UI. On completion, it marks P4 as COMPLETED.
   Upon completion of P4, E_AI_FRONTEND appends a HANDOFF_REQUESTED for P5 to E_HUMAN_QA (and optionally a UX stakeholder), including context (links to deployed preview, metrics endpoints, and test coverage). The atomic engine records OWNERSHIP_TRANSFERRED for P5.
4. Human QA/UX feedback, optional rework loop, and board update
   At 214, E_HUMAN_QA and/or E_HUMAN_DESIGNER review the analytics dashboard. If usability issues are found (e.g., confusing filter controls), P5's owner appends:
      Status_updated for P5: Status=Blocked, Block_reason=“filter UX unclear”.
      A new child task P6: “Refine filter control UX and copywriting,” recorded via TASK_CREATED, with dependencies on P4 and assignment via OWNERSHIP_ASSIGNED to E_AI_FRONTEND or E_HUMAN_D ESIGNER.
   P6 is completed by its owner, and P5 is then set to COMPLETED via STATUS_UPDATED.
   At 216, the project board updates to show the epic as completed, visualizing:
      The decomposition chain from high-level PRD (step 204) to granular tasks (206-208).
      Ownership transitions P1 (PM)→P2 (AI data engineer)→P4 (AI frontend)→P5 (human QA/UX)→P6 (AI or human designer), all driven by ledger events and the atomic ownership protocol.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

Unless otherwise defined, all technical and scientific terms used herein have the same meaning as commonly understood by one of ordinary skill in the art. The materials, methods, and examples provided herein are illustrative only and not intended to be limiting.

Implementation of the method and system of the present disclosure may involve performing or completing certain selected tasks or steps manually, automatically, or a combination thereof. Moreover, according to actual instrumentation and equipment of preferred embodiments of the method and system of the present disclosure, several selected steps may be implemented by hardware (HW) or by software (SW) on any operating system of any firmware, or by a combination thereof. For example, as hardware, selected steps of the disclosure could be implemented as a chip or a circuit. As software or algorithm, selected steps of the disclosure could be implemented as a plurality of software instructions being executed by a computer using any suitable operating system. In any case, selected steps of the method and system of the disclosure could be described as being performed by a data processor, such as a computing device for executing a plurality of instructions.

As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

Although the present disclosure is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may optionally include a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a touch-sensitive layer such as a touchscreen, or keyboard and a pointing device (e.g., a mouse or a trackball), by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and may interact through a communication network. The relationship of client and server arises by virtue of computer programs running on the respective computers and having a client-server relationship to each other.

It should be appreciated that the above-described methods and apparatus may be varied in many ways, including omitting or adding steps, changing the order of steps and the type of devices used. It should be appreciated that different features may be combined in different ways. In particular, not all the features shown above in a particular embodiment or implementation are necessary in every embodiment or implementation of the invention. Further combinations of the above features and implementations are also considered to be within the scope of some embodiments or implementations of the invention.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

Systems and methods disclosed herein involve unconventional improvements over conventional approaches. Descriptions of the disclosed embodiments are not exhaustive and are not limited to the precise forms or embodiments disclosed. Modifications and adaptations of the embodiments will be apparent from consideration of the specification and practice of the disclosed embodiments. Additionally, the disclosed embodiments are not limited to the examples discussed herein.

The foregoing description has been presented for purposes of illustration. It is not exhaustive and is not limited to the precise forms or embodiments disclosed. Modifications and adaptations of the embodiments will be apparent from consideration of the specification and practice of the disclosed embodiments. For example, the described implementations include hardware and software, but systems and methods consistent with the present disclosure may be implemented as hardware alone.

It should be appreciated that the above-described embodiments can be implemented by hardware, or software (program codes), or a combination of hardware and software. If implemented by software, it can be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above-described modules/units can be combined as one module or unit, and each of the above-described modules/units can be further divided into a plurality of sub-modules or sub-units.

The block diagrams in the figures illustrate the architecture, functionality, and operation of possible implementations of systems, methods, and computer hardware or software products according to various example embodiments of the present disclosure. In this regard, each block in a flowchart or block diagram may represent a module, segment, or portion of code, which includes one or more executable instructions for implementing the specified logical functions. It should be understood that in some alternative implementations, functions indicated in a block may occur out of order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as example only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

It will be appreciated that the embodiments of the present disclosure are not limited to the exact construction that has been described above and illustrated in the accompanying drawings, and that various modifications and changes may be made without departing from the scope thereof. Other embodiments will be apparent to those skilled in the art from consideration of the specification and practice of the disclosed embodiments disclosed herein. It is intended that the specification and examples be considered as exemplary only, with a true scope and spirit of the disclosed embodiments being indicated by the following claims.

Computer programs based on the written description and methods of this specification are within the skill of a software developer. The various programs or program modules can be created using a variety of programming techniques. One or more of such software sections or modules can be integrated into a computer system, non-transitory computer readable media, or existing software.

This disclosure employs open-ended permissive language, indicating for example, that some embodiments “may” employ, involve, or include specific features. The use of the term “may” and other open-ended terminology is intended to indicate that although not every embodiment may employ the specific disclosed feature, at least one embodiment employs the specific disclosed feature.

Various terms used in the specification and claims may be defined or summarized differently when discussed in connection with differing disclosed embodiments. It is to be understood that the definitions, summaries and explanations of terminology in each instance apply to all instances, even when not repeated, unless the transitive definition, explanation or summary would result in inoperability of an embodiment.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application. These examples are to be construed as non-exclusive. Further, the steps of the disclosed methods can be modified in any manner, including by reordering steps or inserting or deleting steps. It is intended, therefore, that the specification and examples be considered as exemplary only, with a true scope and spirit being indicated by the following claims and their full scope of equivalents.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant project board will be developed and the scope of the term project board is intended to include all such new technologies a priori.

As used herein the term “about” refers to ±10 %.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for project board-based orchestration of entities collaborating on a project, comprising:
one or more processors configured to:
present on a display, a project board built on a platform designed for collaboration by a plurality of entities, including AI-agent instances and human users;
manage and present within the project board, ledger entries stored by an event-sourced state ledger;
receive high-level user intent for implementing a project;
execute a large language model (LLM) that transforms the high-level user intent into a plurality of granular tasks for execution by entities,
wherein each granular task comprises at least the following data: task ownership assignment, task description, dependency relationships, and completion status;
populate the event-sourced state ledger with the plurality of granular tasks as the ledger entries,
wherein for each granular task that can be performed in accordance with its dependency relationship the system enforces assignment of an owner that is granted permission to update the completion status of the granular task and for enabling the owner to attend to the task according to the task description;
monitor completion statuses for handing-off granular tasks assigned to current owners to other entities via an atomic ownership protocol engine that executes atomic claim-work-handoff transactions designed for preventing concurrent execution conflicts between entities;
update the event-sourced state ledger according to the assigning and/or handing-off; and
update the presentation of the project board according to the updated event-sourced state ledger.

2. The system of claim 1, wherein the atomic ownership protocol engine is configured to prevent concurrent execution of the same granular task by two entities.

3. The system of claim 1, wherein each granular tasks is associated with a plurality of allocated resources for executing the granular task, wherein the atomic ownership protocol engine is configured to deny the plurality of allocated resources access to change the status of the granular task.

4. The system of claim 1, wherein the one or more processors are configured to execute a capacity optimization scheduler operating across a plurality of projects that treats each granular task as a resource-constrained job with capability vectors and deadline constraints.

5. The system of claim 4, wherein the one or more processors are configured to dynamically rebalance the assignments of granular tasks to entities in real-time according to the resource-constrained job determined by the capacity optimization schedule, as granular task dependencies and/or availability of the entities change.

6. The system of claim 1, wherein the one or more processors are configured to compute a priority score for each task as a function of (i) a task dependency graph state and (ii) an AI-agent-task capability similarity metric; and trigger AI-agent instances to select granular tasks with scores exceeds a threshold, and upon completion of the selected granular tasks append a handoff event that deterministically reassigns ownership for review, wherein the handoff event is accompanied with context about the work done by the current owner.

7. The system of claim 6, wherein a capacity optimization scheduler assigns the plurality of entities to granular tasks based on the computed priority scores and based on the capability profiles of the plurality of entities.

8. The system of claim 6, wherein the priority scores are computed based on at least one of: complexity metrics, dependency relationships, and resource availability, to enable autonomous selection and executing of tasks by AI-agent instances operating in parallel.

9. The system of claim 1, wherein the one or more processors are configured for implementing a task-granularity refinement loop, by iteratively collecting feedback regarding execution of each granular task, and programmatically creating at least one child task for at least one granular task, the at least one child task is gated by dependency graph invariants.

10. The system of claim 9, wherein the feedback comprises status input indicative of failure of executing the task, and the at least one child task is created for increasing likelihood of success.

11. The system of claim 9, wherein the one or more processors are configured for computing a level of granularity of the at least one child process based on available resources, wherein weaker AI-agent instances are assigned more simple granular tasks, and strong AI-agents instances are assigned to more complex granular tasks.

12. The system of claim 9, wherein the one or more processors are configured for computing a level of granularity of the at least one child process based on at least one external consideration selected from: financial resource availability, user request, designed amount of collaboration, and requirement for a human in the loop.

13. The system of claim 1, wherein the one or more processors are configured to automatically reassign ownership of a granular task from one entity to another in response to a task status change.

14. The system of claim 1, wherein the one or more processors are configured for maintaining task dependency graphs that prevent task execution conflicts and ensure prerequisite completion before dependent task initiation.

15. The system of claim 14, wherein the one or more processors are configured to dynamically update the task dependency graphs as project scope changes and/or as tasks are dynamically reassigned, and to recalculate priority scores of affected granular tasks.

16. The system of claim 1, wherein the one or more processors are configured to analyze complex project requirements generated in response to the high-level user intent and automatically generate the granular tasks with defined acceptance criteria and deliverable specifications.

17. The system of claim 16, wherein the one or more processors are configured to process product requirement documents and project descriptions through natural language analysis to create actionable granular tasks with appropriate skill requirements and resource allocations.

18. The system of claim 1, wherein the one or more processors are configured to identify maintenance tasks and automatically assigns the identified maintenance tasks to appropriate AI-agent instances based on capability matching and workload optimization.

19. The system of claim 1, wherein the one or more processors are configured to maintain audit trails of ownership changes and task modifications.

20. A computer-implemented method for project board-based orchestration of entities collaborating on a project, comprising:
presenting on a display, a project board built on a platform designed for collaboration by a plurality of entities, including AI-agent instances and human users;
managing and present within the project board, ledger entries stored by an event-sourced state ledger;
receiving high-level user intent for implementing a project;
executing a large language model (LLM) that transforms the high-level user intent into a plurality of granular tasks for execution by entities,
wherein each granular task comprises at least the following data: task ownership assignment, task description, dependency relationships, and completion status;
populating the event-sourced state ledger with the plurality of granular tasks as the ledger entries,
wherein for each granular task that can be performed in accordance with its dependency relationship the system enforces assignment of an owner that is granted permission to update the completion status of the granular task and for enabling the owner to attend to the task according to the task description;
monitoring completion statuses for handing-off granular tasks assigned to current owners to other entities via an atomic ownership protocol engine that executes atomic claim-work-handoff transactions designed for preventing concurrent execution conflicts between entities;
updating the event-sourced state ledger according to the assigning and/or handing-off; and
updating the presentation of the project board according to the updated event-sourced state ledger.
